(19) United States
(12) Patent Application Publication
(10) Pub. No.: US 2024/0367342 A1
(43) Pub. Date: Nov. 7, 2024

(54) ZOSTERA MARINA FIBER OBJECT WITH IMPROVED ACOUSTIC AND THERMAL PROPERTIES

(71) Applicant: Søuld ApS, Læsø (DK)

(72) Inventors: Tobias ØHRSTRØM, København V (DK); Pi Fabrin KARSTENSEN, København N (DK); Gunnar Agerskov MADSEN, Roskilde (DK); Kirsten LYNGE, Hvidovre (DK); Henning Johansen MALMOSE, Læsø (DK); Morten Gyldendal MELBERG, Frederiksberg (DK)

(73) Assignee: Søuld ApS, Læsø (DK)

(21) Appl. No.: 18/557,833

(22) PCT Filed: Apr. 29, 2022
(86) PCT No.: PCT/EP2022/061624

§ 371 Date: Oct. 27, 2023

(30) Foreign Application Priority Data
Apr. 29, 2021 (DK) PA 2021 70196

(51) Int. Cl. B27N 9/00; B27N 3/00; B27N 3/04; B27N 7/00; D04H 1/425; D04H 1/541; D04H 1/542; D04H 1/558; E04B 1/84; E04B 1/94

(52) U.S. Cl. CPC B27N 9/00; B27N 3/002; B27N 3/04; B27N 7/005; D04H 1/425; D04H 1/541; D04H 1/542; D04H 1/558; E04B 1/84; E04B 1/941; D10B 2401/04; D10B 2505/20

(57) ABSTRACT

A method for producing a Zostera marina fiber object includes mixing natural fibers with a solid binding agent and a fire retardant, heating the mixture above a melting and/or softening point temperature of the binding agent, forming the mixture into the shape of the natural fiber object and applying a coating of the fire retardant to the surface of the natural fiber object.

### TECHNICAL FIELD

The disclosure relates to a method for producing natural fiber objects comprising Zostera marina fibers with improved thermal, acoustic and/or fire-repellency properties. Furthermore, the disclosure relates to a natural fiber object obtained by the method and a natural fiber object having a certain composition.

### BACKGROUND

Natural fibers are fibers that are produced by plants, animals or geological processes. Natural fibers have been used by humans for thousands of years to prepare, e.g., textiles and clothing but in the recent years natural fibers and their composites have also been widely used, e.g., in the automobile industry or for the preparation of upcycled compositions for use, e.g., in the building industry.

Zostera marina (also known as eelgrass, seagrass or seawrack) is a flowering vascular plant native to marine environments on the coastlines of northern latitudes, from subtropical to subpolar regions of North America and Eurasia. Zostera marina has long been used as roof thatching in Northern Europe (e.g. on Læsø in Denmark) and it also has been used as fertilizer and cattle fodder in Norway. Some dried uses are also known e.g. to use as stuffing for mattresses and furniture or as an isolation material for filling between the logs of wooden houses (Economic Botany Vol. 57, No. 4 (Winter, 2003), pp. 640-645 (6 pages)).

In the recent years, there has been an increased interest in Zostera marina and other seagrasses and their potential applications as the natural fibers obtained from Zostera marina have relatively high natural fire-resistance compared to other plant-based natural fibers. Additionally, the building industry also has shown interest in natural fibers, including Zostera marina due to its carbon neutrality and natural fire-retardency and has proven its durability over centuries across Scandinavia.

A specialisation report for Bachelor of Architectural Technology and Construction Management at the Copenhagen School of Design and Technology (KEA) (published by Kathryn Larsen) investigated the use of eelgrass as construction material (https://issuu.com/kathrynlarsen/docs/seaweedarchitecture, accessed on 9 Mar. 2021) and details the building material prepared from eelgrass. The report noted that eelgrass do possess natural Class E fire-retardant properties. The acoustic properties detailed in the report include reaching a maximum sound absorption coefficient of 0.90.

The Danish Ministry of Environment and Ministry of Food, Agriculture and Fisheries (https://mst.dk/service/publikationer/publikationsarkiv/2018/jun/rapport-fra-mudp-projekt-om-tangisolering/#:˜:text=MUDP&2Dprojektet20%E2%80%9DB%C3%A6redygtige%20ikke%2D,%2Dm%C3%A5tter%2C%20som%20er%20ikkebrandbare, accessed on 9 Mar. 2021) also investigated the use of eelgrass as building material however the report noted the current limitations due to the inability to reach the sufficient fire classification needed for use as an approved building material.

It is the object of the present disclosure to produce a natural fiber object made of natural Zostera marina fibers with improved thermal, acoustic and/or fire-repellency properties for use as an approved building material to reach the necessary industry standards.

### SUMMARY

The foregoing and other objects are achieved by the features of the independent claims. Further implementation forms are apparent from the dependent claims, the description and the figures.

According to a first aspect, there is provided a method for producing natural fiber object, the method comprising the steps of:
a) mixing Zostera marina fibers with a binding agent and a fire retardant,
b) pre-forming an intermediate object from the mixture,
c) heating the intermediate object above a melting and/or softening point temperature of the binding agent, and
compressing the intermediate object into the shape of the natural fiber object, and
d) allowing the natural fiber object to cool.

By introducing a fire retardant when mixing Z. marina fibers and binding agent may advantageously ensure an even coverage of fibers with fire retardant and binding agent throughout the object. Furthermore, the Z. marina fibres advantageously absorb some of the fire retardant allowing for a more saturated object. This approach may result in natural fiber object containing more fire retardant than possible by only treating a surface of the object later in the process.

In addition, the inventors have surprisingly observed an advantage in fire retardant effectiveness when covering both Z. marina fibres AND the binding agent with fire retardant compared to covering Z. marina fibres only.

By pre-forming an intermediate object from the mixture, determining the final density in terms of grams per square meter is enabled. This results in the ability to obtain final products with different densities with greater predictability. Further, pre-forming can be done on objects having different compositions of Z. marina/binder/fire retardant.

In one possible implementation form of the first aspect, additional fire retardant is added to the pre-formed object prior to heating and compressing it. This may have the advantageous effect of allowing the fire retardant to penetrate deeper into the object.

By heating the intermediate object above a melting and/or softening point temperature of the binding agent, the binding agent may become more malleable and prone to contacting the Z. marina fibers.

In one possible implementation form of the first aspect, the temperature is kept below the activation point of the fire retardant. Consequently, temperature is maintained below 160° C.

By compressing the intermediate object into the shape of the natural fiber object, the desired shape and density of the natural fiber object are obtained.

In one possible implementation form of the first aspect, the method further comprises cutting the fibers such that at least 50% of resulting fibers are between 20 mm and 100 mm in length before mixing in a).

By cutting the natural fiber to a length of 20 mm to 100 mm, it may be ensured that the natural fibers can be packed tightly while creating a porous material with improved thermal and acoustic properties.

By cutting said fibers, a more homogeneous fiber content may be advantageously obtained. By the fiber content being more homogeneous, less fiber material being sorted out and wasted in the following production steps may be ensured. Further, a consistent fiber length may ensure that the weight pr. area of the final product is easier to control and, thus, help limit variations to below +−10% w/a. This may have a direct positive impact on production costs.

In one possible implementation form of the first aspect, the method further comprises drying the fibers such that water content is between 15-30% w/w before mixing in a).

By drying the fibers such that water content is between 15-30% w/w before mixing in a), a drier fiber makes it easier to heat through the product and reduces overall production time. Further, a consistent moisture level in the fibers may reduce evaporation during the following manufacturing processes steps and, thus, may facilitate achieving a consistent weight of the final product. Also, a too dry fiber may be excessively fragile and prone to breaking, which increases waste during production, adversely affecting production costs.

In one possible implementation form of the first aspect, the method further comprises actively drying the fibers. Actively drying the fibers may be carried out by, e.g., placing the fibers in an oven or other methods known in the art, such as blow drying and/or centrifugation. Using active drying may reduce the drying time and, therefore, positively affect production costs.

In one possible implementation form of the first aspect, fire retardant is added to the top surface of the object at the end of the heating/compression cycle.

In one possible implementation form of the first aspect, fire retardant is added to the top surface of the object at the end of the heating/compression cycle in d) before the product is cooled down. This may result in fire retardant accumulating at the surface of the object, which may be beneficial for reducing initial fire combustibility and thereby meeting the requirements of best-in-class fire repellency.

In one possible implementation form of the first aspect, the method comprises mixing natural fibers with a binding agent and a fire retardant, forming an intermediate object from the mixture, heating the mixture above a melting and/or softening point temperature of the binding agent, cooling the intermediate object below the melting and/or softening point temperature of the binding agent, heating the intermediate object above a melting and/or softening point temperature of the binding agent and compressing the object to a certain density.

By having two forming steps to form the intermediate object and the natural fiber object it can be ensured that the fiber layout and density of both the intermediate object and the natural fiber object is increased sufficiently so that the fire retardancy achieves a higher classification when compared to other natural fibers. Further, a denser natural fiber object allows for easier handling, transport and storage when not in use due to its higher stiffness and compactness. By incorporating the fire retardant into the mixture used to formulate the intermediate object and the natural fiber object, the fire retardancy can already reach Class C—s1, d0 fire classification which is sufficient for certain desired applications.

In a possible implementation form of the first aspect, the method comprising applying a coating of the fire retardant to a surface of the intermediate object prior to forming the intermediate object into the shape of the natural fiber object.

By incorporating a fire retardant both in the mixture and on the surface of the natural fiber object, the fire-retardancy of the natural fiber object is raised significantly to a Class B—s1, d0 classification according to EN 13823. The fire retardancy is seen as a cumulative effect of the natural fibers and fire retardant and was unexpected as a Class B fire classification has not been previously broadly achieved using natural fibers to the extend proposed.

In a possible implementation form of the first aspect the method comprises forming an intermediate natural fiber object from the mixture prior to forming the natural fiber object.

In a possible implementation form of the first aspect the method comprises forming the intermediate object into the shape of the natural fiber object by a non-woven technology.

By forming a natural fiber object by using non-woven processes, it may be advantageously possible to better obtain the desired grams per square meter of fibers to form the intermediate object. In addition, the natural fibers adopt a random orientation, which allows for the production of a porous natural fiber object.

In a possible implementation form of the first aspect the method comprises forming the intermediate object by heat compression.

In a possible implementation form of the first aspect the method comprises forming the natural fiber object by heat compression, wherein heating in c) and compressing in d) are carried out simultaneously.

By using heat compression, it becomes possible to tightly pack the natural fibers resulting in an increased sound absorption and to shape the natural fiber object to a desired shape.

By heating and compressing simultaneously, activating the binding agent and creating connections between the fibers may be advantageously achieved. Furthermore, a better surface finish and accurate density may advantageously be enabled.

In a possible implementation form of the first aspect the method comprises compressing the natural fiber object after heating in c).

By using Zostera marina as a natural fiber, the naturally present fire-retardancy can be increased significantly and unexpectedly for a natural fiber material to create a natural fiber object with high density for enhanced sound absorption and fire-retardant properties that are approved by industry standards for use as building materials.

In a possible implementation form of the first aspect the method the binding agent is a monofiber or bi-component binding agent.

In a possible implementation form of the first aspect the binder is a biodegradable binder.

In a possible implementation form of the first aspect the binding agent is selected from PE/PP, PET/PE, PET/CO-PET, bio-polyester, PLA, PLA/co-PLA, bio-PE/PP or PLA/PBS.

In a possible implementation form of the first aspect the intermediate object is formed at temperatures between 85° C. and 160° C.

By choosing a binding agent, it can be ensured that the binding agent has a reduced flammability to not contribute to the flammability of the natural fiber object and to help obtain the necessary density for achieving the desired sound absorption properties. Further, the production temperature between 85° C. and 160° C. does not damage the fibers and does not influence the quality of the fire retardant.

In a possible implementation form of the first aspect the fire retardant comprises phosphorous and/or non-combustible inorganic salts.

Phosphorous and many of its salts have natural fire-retardant effect and is one of the most effective fire retardants, hence a fire-retardant effect can be obtained even by using small quantities, minimizing the degradation of the physical properties of the natural fiber object. Further, phosphorous and its salts are effectively harmless substances with low toxicity, making it suitable to incorporate to the natural fiber object which is to be used indoors.

In a possible implementation form of the first aspect the method the binding agent and the fire retardant is non-toxic.

By using a phosphorous or phosphorous-based compounds, e.g., phosphate salts or other, non-combustible inorganic salts as fire-retardants it can be ensured that the flammability of the natural fiber object is significantly reduced, and that the combustion of the natural fiber object is delayed. By forming an outer coating on the natural fiber object, a protective layer is formed preventing the underlying material from igniting and by incorporating the fire retardant to the natural fiber object it can be ensured that the internal flammability of the natural fiber object is significantly reduced.

In a possible implementation form of the first aspect the method further comprising drying the natural fiber object after the coating of the fire retardant to the surface of the natural fiber object.

By drying the natural fiber object, any harmful fumes released from the natural fiber object during production are dissipated making the natural fiber object safe for, e.g., indoor use.

In a possible implementation form of the first aspect the method further comprising incorporating a reactive fire retardant granulate into said natural fiber mixture and applying an additive aqueous fire retardant to the surface of the natural fiber object for increased fire resistance.

In a possible implementation form of the first aspect the fire retardant is a reactive fire retardant granulate.

In a possible implementation form of the first aspect the fire retardant is an additive aqueous solution fire retardant.

In a possible implementation form of the first aspect the fire retardant is a combination of a reactive fire-retardant granule and an additive aqueous fire-retardant solution.

By utilizing a granulate fire retardant it may be ensured that the fire retardant is incorporated into the natural fiber object. By utilizing an aqueous fire-retardant solution it may be ensured that the outer surface of the natural fiber object is impregnated with an extra layer of fire retardant.

While seagrass naturally can achieve a Class E fire classification properties, surprisingly, the mixture of the binder, fire retardant and the fiber appear to have synergistic effect on significantly raising the fire retardancy properties of the natural fiber object, achieving an unusually high fire classification class that is not usual for nature-based products or natural fibers.

In a possible implementation form of the first aspect the method comprises compressing the natural fiber object to a final density of 25 kg/m³ to 500 kg/m³, such as of 50 kg/m³ to 250 kg/m³, such as of 75 kg/m³ to 180 kg/m³, such as of 100 kg/m³ to 150 kg/m³, such as approximately 120 kg/m³.

By having a final density of 50 kg/m³ to 500 kg/m³ it may be ensured that the natural fiber object possesses superior sound absorption qualities, able to achieve class A sound absorption classification according to ISO 354.

According to a second aspect, there is provided a natural fiber object comprising Zostera marina fibers, a binding agent and a fire retardant.

In a possible implementation of the second aspect the natural fiber object comprises 50-95% w/w Zostera marina fibers, 4-30% w/w binding agent and 5-40% w/w fire retardant.

By combining the natural fiber, binding agent and fire retardant in suitable quantities obtaining a natural fiber object with exceptional thermal and acoustic properties may be obtained.

In a possible implementation of the second aspect fiber density within the natural fiber object is comprised between 50 kg/m³ and 500 kg/m³.

By having a final density of 50 kg/m³ to 500 kg/m³ it may be ensured that the natural fiber object possesses superior sound absorption qualities, able to achieve class A sound absorption classification according to ISO 354.

In a possible implementation of the second aspect the natural fiber object comprises fire retardant between the fibers and/or on one or two surfaces.

By the natural fiber object comprising fire retardant between the fibers Z. marina fibers advantageously absorb some of the fire retardant allowing for a more saturated object. This approach may result in natural fiber object containing more fire retardant than possible by only treating a surface of the object later in the process.

In addition, the inventors have surprisingly observed an advantage in fire retardant effectiveness when covering both Z. marina fibres AND the binding agent with fire retardant compared to covering Z. marina fibres without binder.

In a possible implementation of the second aspect the amount of fire retardant is 0.5%-5% w/w higher on a surface compared to half way through a thickness comprised between two opposite sides of the object.

Fire retardant accumulating at the surface of the object which may be beneficial for reducing initial fire combustibility of the natural fiber object.

In a possible implementation of the second aspect the natural fiber object comprises an approximately homogeneous fiber density through a side-to-side cross-section measured in kg/m³. This results in a single-layer natural fiber object, which is advantageously easy and fast to manufacture, thereby decreasing production costs.

In a possible implementation of the second aspect the fiber density variation across a side-to-side cross-section of the natural fiber object measured in kg/m³ does not exceed 10%, thus ensuring consistency in the acoustic and thermal properties of the object.

In a possible implementation of the second aspect airflow resistivity corresponds to an r value of between 50, 000-90, 000 KPa s/m2

In a possible implementation of the second aspect the product has an acoustic performance corresponding to a Weighted Sound Absorption coefficient Alpha w of at least 0.6 or a Noise Reduction Coefficient NRC of at least 0.5.

As described herein elsewhere, it is the combined properties such as inherent properties of Z. marina fibers, density, fiber homogeneity, compaction, fiber density, binder content, fire-retardant content and distribution, and/or air permeability that ensure the acoustic, thermal and fire-repellency properties of the natural Z. marina fiber object.

According to a third aspect, a natural fiber object obtainable by the method according to any one implementation form of the first aspect as described herein.

These and other aspects will be apparent from and the embodiment(s) described below.

### BRIEF DESCRIPTION OF THE DRAWINGS

In the following detailed portion of the present disclosure, the aspects, embodiments and implementations will be explained in more detail with reference to the example embodiments shown in the drawings, in which:

FIGS. 1a, 1b and 1c shows a sectional view of a natural fiber object prepared in accordance with an embodiment;

FIG. 2a-2d shows examples of various shapes and configurations of a natural fiber object in accordance with an embodiment;

FIG. 3 is a graph showing the acoustic properties of a natural fiber object prepared in accordance with an embodiment in comparison to other natural fibers;

FIG. 4 is a graph showing the fire classification of a natural fiber object prepared in accordance with an embodiment in comparison to other natural fibers.

### DETAILED DESCRIPTION

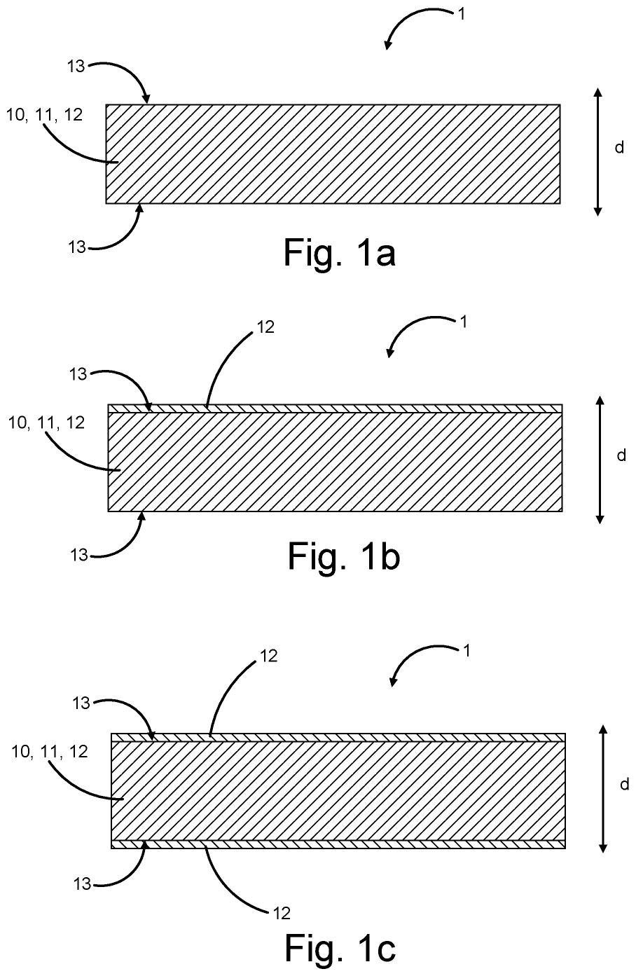

FIGS. 1a, 1b and 1c show a sectional view of an object 1 prepared in accordance with an embodiment.

The natural fiber object 1 comprise natural fiber 10, binding agent 11 and fire retardant 12 as shown on FIG. 1a. The natural fiber object also comprises a surface 13.

The surface 13 of the natural fiber object 1 may be partly coated with a layer of fire retardant 12 as shown in FIG. 1b. The surface may be the top surface of the bottom surface or side surfaces depending on need and application of the natural fiber object 1. Multiple surfaces 13 of the natural fiber object may also be coated or impregnated with a layer or multiple layers of fire retardants as shown on FIG. 1c.

The natural fiber may be produced by plants and may be e.g. seed fiber, leaf fiber, bast fiber, fruit fiber or stalk fiber. A suitable natural fiber is seagrass in accordance with an embodiment as e.g. Zostera marina is naturally washed ashore which makes collection and handling easier, however other seagrasses belonging to e.g. Posidoniaceae e.g. Posidonia oceanica, Zosteraceae, Hydrocharitaceae and Cymodoceaceae families are also suitable.

The collected seagrass is spread for washing and drying and may or may not be turned or moved in order to assist the drying using conventionally techniques known in the art. The seagrass is washed with at least 0.5-1 liter of water per kg seagrass e.g. rainwater, freshwater, industrial water etc. in order to reduce the amount of natural seawater resins present on the seagrass surface, e.g. sea salt.

The seagrass is dried e.g. naturally over a period of 2-4 weeks or mechanically e.g. by airdrying, pressing, by using desiccants, microwave drying, freeze-drying or any other known drying methods to reach an average water content below 20%.

The washed and dried seagrass may be stored for further handling e.g. by a conventional baler or other conventional methods.

The seagrass may be cut to shorter fibers. Possible fiber lengths include an average length of 5 mm to 200 mm. The fiber lengths may also have an average length of 10 mm to 350 mm. The length of the seagrass fiber influences the porosity and the quality of the natural fiber object and it was found that it was advantageous if the fibers were relatively short to obtain a more homogenous material and a higher density. However, the length of the fiber shall be optimally selected to have fibers as long as possible to obtain a smoother surface finish and a natural fiber object with improved aesthetic qualities without compromising the homogeneity of the natural fiber object. The cutting may be by conventionally known methods, e.g. by shearing, chopping, cutting, shredding, milling, slicing etc.

Impurities may be removed such as sand, stone, dust etc. by conventional removal methods, e.g. by filtering, sieving etc.

The seagrass is mixed with a binding agent or a binder. In an embodiment the binding agent constitute 4% to 30% weight of the natural fiber object. In yet another embodiment, the binding agent constitute 5% to 15% of weight of the natural fiber object. The amount and type of binding agent may be in dependence of the product to be produced by the method. In a yet further embodiment of the method according to the invention, the binding agent may be a thermoplastic binder, i.e. polymer that becomes softer when heated and hardens when cooled, which allows for easier handling during the production process steps. The binder may be a solid binding agent or a wet binding agent. In an embodiment, a combination of solid and wet binding agents may also be used. In yet another embodiment, a combination of solid binding agents may be used. In yet another embodiment, a combination of wet binding agents may be used.

Suitable binding agents may be e.g. monofibers or bi-component fibers. Suitable binding agents may also be biodegradable binders or a mixture of various commercially available binding agents. Suitable binding agents may be e.g. PE/PP bi-component fibers, PET/PE bi-component fibers, PET/co-PET bi-component fibers.

Suitable biodegradable fibers may be e.g. biopolyester or PLA resin. Other suitable polyesters with fire-retardant properties may also be used, e.g. PET monofibers. Biopolymer fibers may also be used e.g. PLA monofibers, BIO PE/PP biocomponent fibers, PLA monofibers, PLA/co-PLA monofibers or PLA/PBS bicomponent fibers. The binding agent may also be a non-toxic binding agent.

The fiber-binding agent mix may also be further impregnated with a fire retardant. In an embodiment, the fire retardant may constitute 5% to 40% weight of the natural fiber object. In yet another embodiment, the fire retardant may constitute 10% to 25% weight of the natural fiber object. The fire retardant may be a reactive fire retardant and comprise of granules. The fire retardant may also comprise suitable non-combustible inorganic salts which may be commercially available. Inorganic salts may be e.g. sodium, magnesium or potassium-based salts, and may be e.g. ammonium chloride, magnesium sulfate or ammonium sulfate etc. Reactive fire retardants may be e.g. Paxymer©, Flamestab NOR 116© or AddWorks LXR 920© or other suitable formulations. In an embodiment, the fire retardant comprises phosphorous-based salts. Phosphorous-based salts, such as ammonium phosphate, ammonium polyphosphate, ammonium pyrophosphate, tetrapotassium pyrophosphate, or diammonium phosphate were found to work efficiently with natural fibers prepared from seagrass and it was also found that smaller quantities of the fire retardant may be used while reaching the desired fire classification, resulting in an overall reduced production cost of the natural fiber object.

The fire retardant may also be an additive fire retardant and may be an aqueous solution. The fire retardant may be commercially available. Additive fire retardants may be e.g. Firestop 11©, Firestop 88©, Firestop 100©, Firestop 00©, Exolit AO 420©, Apyrum 201© or Apyrum 101© or Burnblock MM50© or Burnblock JG30© or other suitable formulations.

Other suitable fire retardants may be additive flame retardants and may be commercially available. The fire retardant may also be non-toxic. In an embodiment, a single type of suitable fire retardant may be used. In yet another embodiment, a combination or two or more suitable fire retardants may also be used.

The fiber, binding agent and fire retardant mix is dried using conventional drying methods to a moisture content of 5% to 30%. The drying may also be achieved by conventional drying techniques.

The intermediate object is formed prior to the formation of the final shape of the natural fiber object, and it may be prepared by heating the mixture above the softening point temperature of the binding agent to activate the binding agent and create connections between the fibers. In an embodiment, the intermediate object is formed at temperatures between 85° C. and 160° C. The intermediate object may be formed using conventional compression techniques, e.g. by applying isotropic force or by utilizing woven or non-woven techniques, allowing for a more compact packing of fibers and consequently a higher density natural fiber object. The intermediate object may also be formed using e.g. heat compression, heat press or e.g. using steam press etc.

The intermediate object may have various forms and shapes and the intermediate object may already have the shape and/or density of the natural fiber object. The intermediate object may have the shape of e.g. a square, triangle, rectangle or any other suitable or desired shapes. The intermediate object may have a width between 400 mm-2400 mm, length between 1 mm-3500 mm and height between 3 mm to 100 mm depending on desired shape and usage of the consequently produced natural fiber object. The height of the intermediate object may also be between 35 mm to 95 mm.

The heating and compression steps may be carried out simultaneously or in a step-wise process.

The intermediate object may be cooled after forming, e.g. by passing through a cooling unit or by other cooling means.

The natural fiber object may be prepared by heating and compressed by repeating the heating and compression steps described for the intermediate product to achieve a smoother surface finish and the required density dependent on the required application of the natural fiber object. In some applications the intermediate natural fiber object may be used as the final natural fiber object without further modifications. The density of the natural fiber object may be in the range of 25-750 kg/m³. The density of the natural fiber object may also be around 120 kg/m³. In an embodiment, the natural fiber object is formed at temperatures between 85° C. and 160° C.

The surface 13 of the natural fiber object 1 may be coated by the fire retardant 12 as seen on FIGS. 1b and 1c. The fire retardant 12 may be the same fire retardant or another suitable fire retardant as used in the mixture used for the formation of the natural fiber object 1. In an embodiment, a granulate fire retardant 12 may be added to the mixture for formation of an object and a liquid fire retardant 12 may be applied as a coating to the surface 13 of the natural fiber product 1. In an embodiment, the fire retardant 12 may be applied to the surface of the natural fiber object 1 prior to or immediately after forming the shape of the natural fiber object 1. In another embodiment, the coating of the fire retardant to may be applied to the surface of the intermediate object prior to forming the intermediate object into the shape of the natural fiber object. In yet another embodiment, the coating of the fire retardant may be applied in a one-step or multiple-step coating process, e.g. by applying a layer of coating of the fire retardant to a surface of the intermediate object prior to forming the intermediate object into the shape of the natural fiber object followed by a second step of applying a coating of the fire retardant to a surface of the natural fiber object. After coating with the liquid fire retardant, it is allowed to penetrate into a surface layer 13. The surface layer 13 is the outermost surface of the natural fiber object 1 and the fire retardant 12 forms an extra layer of fire protection, increasing the overall fire retardancy of the natural fiber object 1. The natural fiber object 1 may be dried after coating with fire retardant 12 using conventional drying methods.

The natural fiber object may comprise 50-95% by weight of natural fiber, 4-30% by weight binding agent and 5-40% by weight fire retardant. In another embodiment, the natural fiber object comprises 65-75% by weight natural fiber, 5-15% binding agent and 12-22% by weight fire retardant. In yet another embodiment, the natural fiber object comprises 72% weight natural fiber, 10% weight binding agent and 18% weight fire retardant.

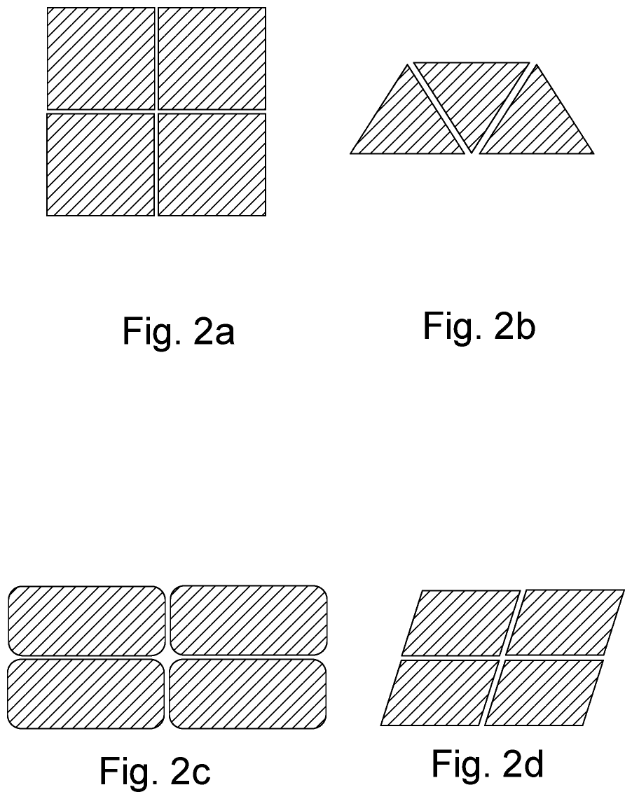

FIGS. 2a to 2d show various shapes prepared in accordance with an embodiment. The intermediate object may be cut after cooling to desired shapes and forms depending on the desired application to form the natural fiber object.

The intermediate object may be cut to a width of 10-2400 mm and length of 10-3100 mm to form the natural fiber object. The natural fiber object may have various shapes and may be e.g. square shaped, triangular, rectangular or any other suitable shapes. To cover a larger surface area of e.g. a wall or flooring or ceiling, the natural fiber objects may be installed with either adhesive, screws, wood panels or other mechanical connections. The mounting principles should be selected depending on the conditions of the site's surfaces or on other aesthetic preferences.

The natural fiber object prepared in accordance with an embodiment exhibits fire retardant and acoustic properties that are unexpected for natural fiber-based objects.

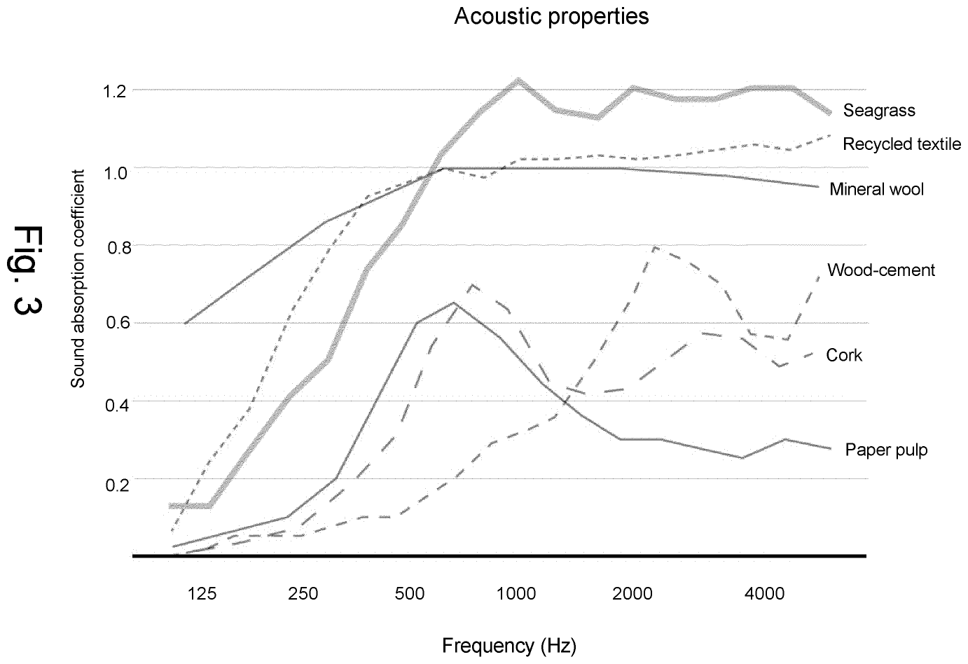

Surprisingly it was found that the acoustic properties of seagrass are enhanced significantly in the natural fiber object in comparison with other natural fibers (FIG. 3). The natural fiber object prepared in accordance with an embodiment shows superior acoustic properties which is unexpected. The presence of the binding agent and fire retardant seem to have a supplemental effect on the efficiency of the natural fiber object made of seagrass which is not seen with other natural fibers investigated. The length of the natural fibers and the binding agent as well as the density and porosity of the natural fiber object prepared in accordance with an embodiment collectively seem to contribute to achieving the surprising acoustic properties.

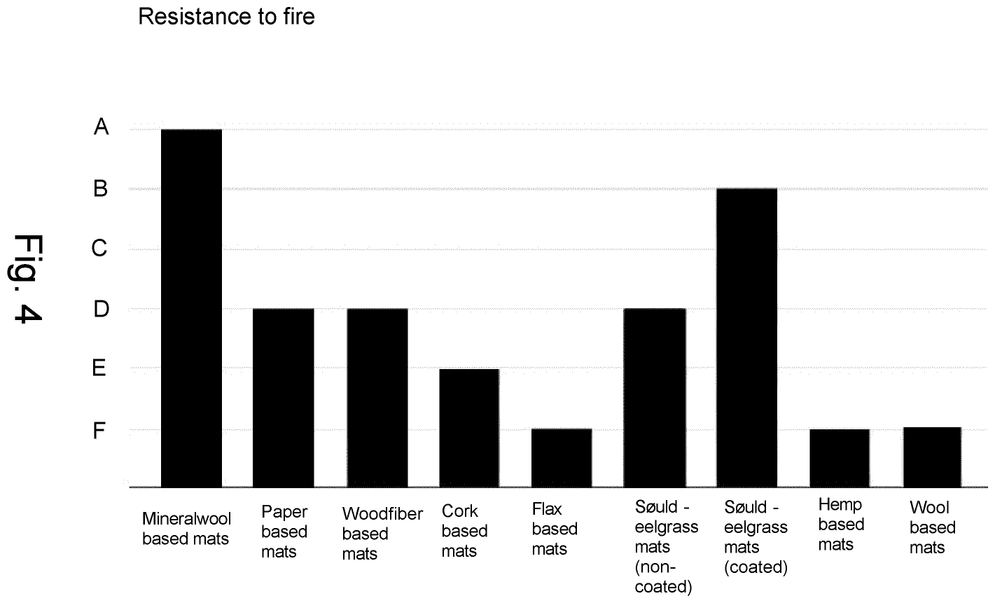

FIG. 4. shows the fire classification of various natural fibers. Mineral wool is a well-known fire class Class A insulation material. While some other natural fibers also show natural fire retardant properties, most are unsuitable for use as e.g. construction materials due to strict fire-retardancy requirements and standards present in the building industry (which also often applies to interior insulation as well).

It is not known that a class B fire classification was previously reached using seagrass as a natural fiber, albeit the effort and heightened interest in the recent years.

While seagrass naturally possess class E fire classification as shown on FIG. 4, the addition of suitable fire retardants both to the fiber mixture and as an additional surface layer increase the fire classification of the natural fiber object to class B as shown on FIG. 4. The natural fiber object prepared in accordance with an embodiment possess unexpected fire-retardant properties and achieved a B-s1, d0 fire classification according to EN 13823. It seems that a suitable combination of seagrass, binding agent and fire retardant collectively increase the fire-retardancy and thermal insulating properties, however it is hypothesized that the thickness, density and porosity of the natural fiber object collectively contribute to these unexpected properties.

### Example 1—Composition

The natural fiber object is prepared in accordance with an embodiment.

Natural fiber from seagrass is cut to a length of 5-100 mm. The natural fibers are then mixed with 10% binding agent (Fibervisions©, Denmark) 14-16% and fire retardant (Burnblock©, Denmark). The mixture was formed using a non-woven process and was heated at 120-160° C. to activate the binding agent. The mixture was additionally formed into the shape of the intermediate object by heat compression to achieve a thickness of 70 mm+/−2 mm and was cut to a width of 1200 mm and length of 3100 mm (as seen e.g. on FIG. 1a to FIG. 1c). The intermediate object was cooled to set the object. The heating and compression-steps were repeated in a heatpress to achieve a natural fiber object with a thickness of 40 mm+/−2 mm and a smoother surface finish and a density of 120 kg/m³. A final coating of 2-5% fire retardant was applied and the fire retardant was allowed to penetrate the surface of the natural fiber object. The natural fiber object was dried.

The natural fiber object comprises 71% of fiber, 10% of binder and 19% fire retardant and is tested for fire-retardancy and sound absorption.

### Example 2—Flammability Testing

40 mm thick (density 120 kg/m³) & 20 mm thick (density 240 kg/m³) natural fiber object was prepared in accordance with example 1 and was tested for flammability according to EN 13823:2010.

The specimen was fixed with screws and the substrate was gypsum plasterboard.

Achieved results: Class A2/B (non-combustible/very limited contribution to fire)

Smoke production: s1 (little or no smoke emitted during the first 10 minutes of exposure to fire)

Flaming droplets/particles: d0 (no flaming droplet/particle formation within the first 10 minutes of fire exposure)

Hence a total indicative classification B-s1, d0.

A single flame source test (ISO 11925) was performed for a natural fiber object of 40 mm (density 120 kg/m³) using ‘Flame Application position test’—i.e. measuring the length of the flame that develops over time.

The initial testing was carried with a direct flame for 30 seconds and the natural fiber object achieved class B classification.

### Example 3—Sound Absorption

Acoustic measurement of the sound absorption coefficient was performed for 40 mm (density 120 kg/m³) of natural fiber object prepared in accordance with example 1.

The measurements were made in accordance with DS/EN ISO 354 and the sound absorption class was determined in accordance with DS/EN ISO 11654.

Based on the measurements, the sound absorption coefficient was calculated in 1/3-octave bands between 100 Hz and 5000 Hz and in 1/1-octave bands between 125 and 4000 Hz. Furthermore, the weighted absorption coefficient and NRC values were calculated.

In the test minimum 10 m² of natural fiber object was tested directly on the floor and achieved aw=0.85 and class B (mh).

In the test minimum 10 m² of natural fiber object was tested mounted 10 mm from the floor and achieved aw=1, 0 Class A.

The various aspects and implementations have been described in conjunction with various embodiments herein. However, other variations to the disclosed embodiments can be understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

The reference signs used in the claims shall not be construed as limiting the scope. Unless otherwise indicated, the drawings are intended to be read (e.g., cross-hatching, arrangement of parts, proportion, degree, etc.) together with the specification, and are to be considered a portion of the entire written description of this disclosure.

1-18. (canceled)

19. A method for producing natural fiber object, the method comprising the steps of:
a) mixing seagrass fibres, such as Zostera marina or Posidonia oceanica fibers with a binding agent and a fire-retardant to obtain a mixture,
b) pre-forming an intermediate object from the mixture,
c) heating the intermediate object above a melting and/or softening point temperature of the binding agent to activate the binding agent and create connections between the fibers, and
compressing the intermediate object into the shape of the natural fiber object,
d) allowing the natural fiber object to cool, and
e) applying a coating of the fire-retardant to a surface of the intermediate object or the natural fibre object,
wherein the temperature in c) is below an activation point of the fire retardant.

20. The method according to claim 19, further comprising cutting the fibers such that at least 50% of resulting fibers are between 20 mm and 100 mm in length before mixing in a).

21. The method according to claim 19, further comprising drying the fibers such that water content is between 15-30% w/w before mixing in a).

22. The method according to claim 19, wherein fire-retardant is coated on a surface of the heated intermediate object obtained in c) before allowing the natural fiber object to cool in d).

23. The method according to claim 19, comprising forming the intermediate object into the shape of the natural fiber object by a non-woven technology.

24. The method according to claim 19, wherein the natural fiber object is compressed after heating in c).

25. The method according to claim 19, wherein heating temperature in c) is between 85° C. and 160° C.

26. The method according to claim 19, wherein the binding agent is selected from PE/PP, PET/PE, PET/co-PET, bio-polyester, PLA, PLA/co-PLA, bio-PE/PP or PLA/PBS.

27. The method according to claim 19, further comprising drying said natural fiber object after said coating of the fire-retardant to the surface of the natural fiber object.

28. A natural fiber object obtainable by the method of claim 19, comprising seagrass fibers, such as Zostera marina or Posidonia oceanica fibers, a binding agent and a fire retardant, wherein the amount of fire-retardant is 0.5%-5% w/w greater on a surface compared to halfway through a thickness comprised between two opposite sides of the object.

29. The natural fiber object according to claim 28 comprising 50-95% of seagrass fibers, 4%-30% w/w of a binding agent and 1%-40% w/w of a fire retardant, such as 5%-25% w/w of a fire retardant.

30. The natural fiber object according to claim 28, wherein Zostera marina and/or Posidonia oceanica fibers are the only organic fibers comprised in the natural fiber object, excluding negligeable amounts of other organic fibres.

31. The natural fiber object according to claim 28 comprising fire-retardant between the fibers and/or on one or two surfaces.

32. The natural fiber object according to claim 28 comprising an approximately homogeneous fiber density through a side-to-side cross-section measured in kg/m³.
